(19) United States
(12) Patent Application Publication
(10) Pub. No.: US 2019/0014026 A1
(43) Pub. Date: Jan. 10, 2019

(54) METHOD AND APPARATUS FOR IGNITION STATE MONITORING

(71) Applicant: Ford Global Technologies, LLC, Dearborn, MI (US)

(72) Inventors: Khaled Bahar, Dearborn Heights, MI (US); Nehal Uddin, Canton, MI (US)

(21) Appl. No.: 15/641,753

(22) Filed: Jul. 5, 2017

(51) Int. Cl. H04L 12/26; H04L 29/08; G06F 9/44; G06F 11/07

(52) U.S. Cl. CPC H04L 43/0817; H04L 67/12; G06F 11/0739; G06F 11/0757; G06F 8/68

(57) ABSTRACT

A system includes a processor configured to maintain a perpetual connection to a vehicle communication device, barring environmental interference or vehicle communication device failure. The processor is further configured to receive data packets from the vehicle communication device indicating an ignition state change and determine a present vehicle ignition state based on the data packets.

### TECHNICAL FIELD

The illustrative embodiments generally relate to methods and apparatuses for ignition state monitoring.

### BACKGROUND

As vehicles grow increasingly software dependent, the need for constant updating of software on various vehicle systems continues to grow. When there were limited software packages in vehicles, and limited vehicles with updateable software, original equipment manufacturers (OEMs) could rely on dealer-installed updates. Customers may have had the option to download and manually install updates as well, but the limited scope of software in the early phases limited the need and criticality of updates.

As vehicle software systems grow, on-demand updating is becoming more pressing of an issue. One common solution to this problem involves sending over the air (OTA) updates, which allows delivery of a new software package to any vehicle with remote connectivity. This sort of system provides for near-continual update capability, and helps keep vehicles up to date and users happy.

Since the software update is being done in a vehicle, several considerations exist that often dictate the feasibility of an update at a particular time. When downloading the file, the vehicle often needs to be in a key-on or started state. This will, in most cases, facilitate an open remote connection to the software-providing server. If the server believes the vehicle is in the correct state, the server may send a large update, which can take significant time to download, in some instances. If the server is unaware of, or incorrect with regards to, the ignition state, some or all of the transfer may fail. Also, since the vehicle state may fluctuate with a driver's usage, it can be difficult to rely on old information relating to a predicted vehicle state, based on a previously detected and broadcast state.

### SUMMARY

In a first illustrative embodiment, a system includes a processor configured to maintain a perpetual connection to a vehicle communication device, barring environmental interference or vehicle communication device failure. The processor is further configured to receive data packets from the vehicle communication device indicating an ignition state change and determine a present vehicle ignition state based on the data packets.

In a second illustrative embodiment, a system includes a processor configured to determine that an update is available for a vehicle. The processor is also configured to query a vehicle watchdog process, designed to maintain perpetual vehicle connectivity, absent environmental interference or hardware failure, for a current vehicle ignition state. The processor is further configured to deliver a data payload responsive to receiving an indication from the watchdog process that the vehicle ignition state matches a state designated for payload delivery

In a third illustrative embodiment, a computer-implemented method includes maintaining a perpetual connection to a vehicle communication device, absent environmental interference or vehicle communication device failure. The method also includes receiving data packets from the vehicle communication device indicating an ignition state change and determining a present vehicle ignition state based on the data packets.

### BRIEF DESCRIPTION OF THE DRAWINGS

FIG. 1 shows an illustrative vehicle computing system;

FIG. 2 shows an illustrative example of an ignition state reporting process;

FIG. 3 shows an illustrative example of a delivery instruction process; and

FIG. 4 shows an illustrative example of an update confirmation process.

### DETAILED DESCRIPTION

As required, detailed embodiments are disclosed herein; however, it is to be understood that the disclosed embodiments are merely illustrative and may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the claimed subject matter.

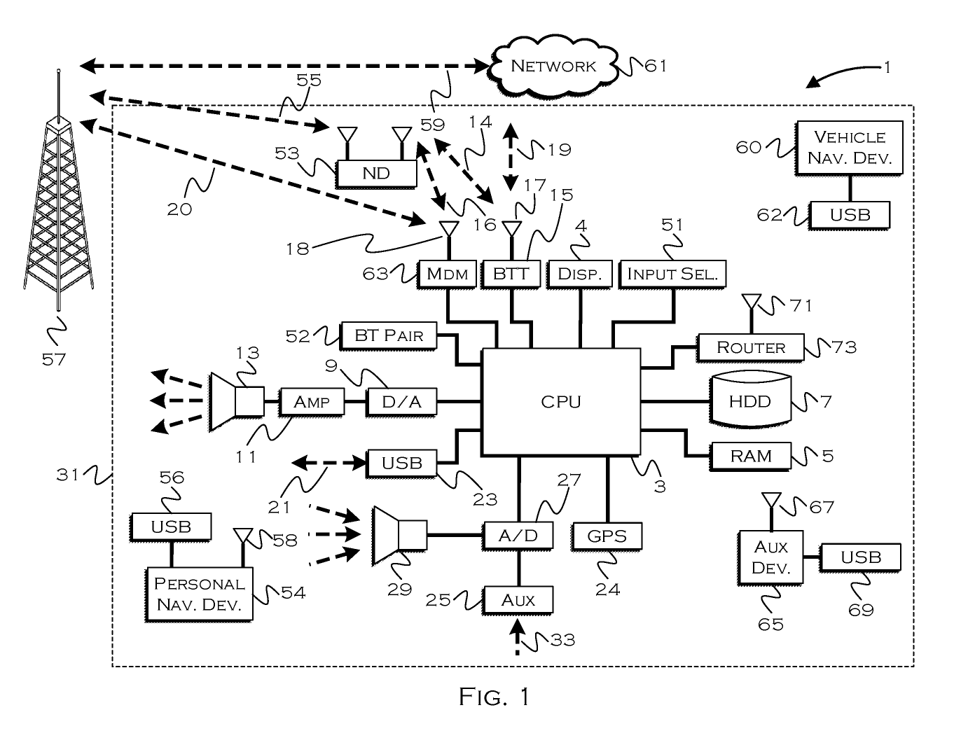

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, spoken dialog system with automatic speech recognition and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory. In general, persistent (non-transitory) memory can include all forms of memory that maintain data when a computer or other device is powered down. These include, but are not limited to, HDDs, CDs, DVDs, magnetic tapes, solid state drives, portable USB drives and any other suitable form of persistent memory.

The processor is also provided with a number of different inputs allowing the user to interface with the processor. In this illustrative embodiment, a microphone 29, an auxiliary input 25 (for input 33), a USB input 23, a GPS input 24, screen 4, which may be a touchscreen display, and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a Wi-Fi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include Wi-Fi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of Code Domain Multiple Access (CDMA), Time Domain Multiple Access (TDMA), Space-Domain Multiple Access (SDMA) for digital cellular communication. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., Wi-Fi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (FireWire™ (Apple), i.LINK™ (Sony), and Lynx™ (Texas Instruments)), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a Wi-Fi (IEEE 803.11) 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing that portion of the process, since the wireless device would not “send and receive” information with itself. One of ordinary skill in the art will understand when it is inappropriate to apply a particular computing system to a given solution.

In each of the illustrative embodiments discussed herein, an exemplary, non-limiting example of a process performable by a computing system is shown. With respect to each process, it is possible for the computing system executing the process to become, for the limited purpose of executing the process, configured as a special purpose processor to perform the process. All processes need not be performed in their entirety, and are understood to be examples of types of processes that may be performed to achieve elements of the invention. Additional steps may be added or removed from the exemplary processes as desired.

With respect to the illustrative embodiments described in the figures showing illustrative process flows, it is noted that a general purpose processor may be temporarily enabled as a special purpose processor for the purpose of executing some or all of the exemplary methods shown by these figures. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

Telematics and connected services provide a variety of functionality to a vehicle computer. One of the uses of telematics systems is to update vehicle software via over the air (OTA) updates. These updates are often downloaded and installed based on original equipment manufacturer (OEM) specified parameters, which can include reference to ignition states. Different models may be used for download and installation of OTA updates, and many of the models implement one aspect of the process based on a current vehicle ignition state.

In the current model, vehicles use SMS to convey an ignition status to a backend server, which is responsible for managing the updates. There are potential issues with using SMS, however, such as the fact that SMS delivery is not always guaranteed. Further, SMS may have a delivery delay time associated therewith, and both of the preceding factors can result in uncertainty with regards to the actual ignition status. If a cloud-based update management system implements a download instruction to send binaries (files for updating a vehicle module) based on ignition status, it is useful for the management system to know the present ignition status, so that a download can be initiated or interrupted as needed.

When the system uses SMS, the current status report may be delayed or even failed to be delivered, which can result in a vehicle ignition state expectation on the backend which does not actually mirror the present ignition state. The failure can occur, for example, due to circuit switch failure, whereby insufficient circuit switch channels exist to send an SMS message, which can delay or interrupt an SMS message informing the remote server (which relies on the SMS message) of the current ignition state. This can result in an eventual failure of the update, due to an incorrect understanding on the remote, update-server-side, of the current vehicle ignition state.

This situation effectively results in many hit-or-miss transactions relating to updates, where the update server is essentially forced to send a blind update and hope the vehicle ignition state reported by the last successful SMS message is still the present ignition state.

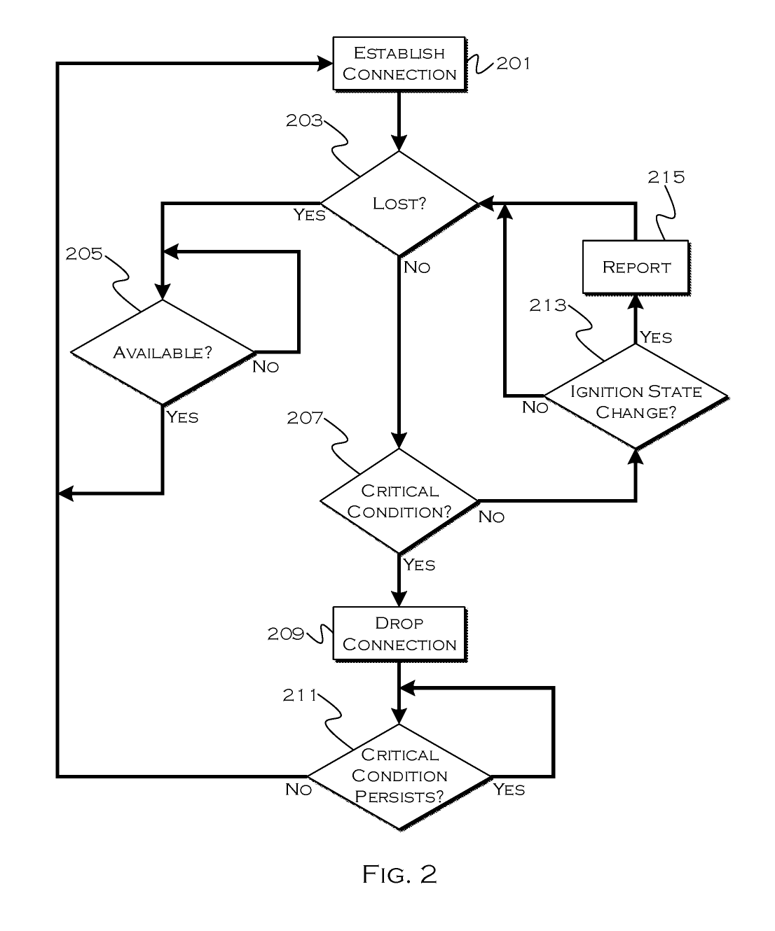

FIG. 2 shows an illustrative example of an ignition state reporting process. In this example, the process establishes 201 a connection between the vehicle and the cloud. This connection is an always-on connection, and may be intended to only be interrupted when environmental variables (no available signal for connection) dictate that the connection cannot be maintained. This could be when a user is deep within a parking structure or otherwise cannot access a cellular or other remote connectivity option.

If the signal is lost 203, the process will loop to check 205 for any available connection option that will allow the connection to be re-established. If and when the connection is available, the process again reconnects the two entities (vehicle and cloud) so that the connection persists whenever possible.

Dangerously low power states and other driver-experience-related concerns may be other reasons why a connection would drop, and in those cases the connection would re-establish once the likelihood of driver-impact was mitigated (e.g., the vehicle battery was sufficiently charged). If the process encounters 207 a critical condition (which could be OEM or driver defined) likely to impact a driver experience, the process may voluntarily drop 209 an otherwise available connection. This could be, for example, a vehicle battery running low, or accessory or local power being needed for a different driver request. As long as the critical condition persists 211, the process does not reconnect. Once the critical condition ends, the process may reconnect the vehicle to the cloud.

While the process is connected, the process uses packet data to report 215 any detected 213 ignition state changes. This reporting is near-instantaneous, and will be able to have delivery assurance (if the connection is established) along with accuracy assurances (since reports can be sent successively and quickly if the ignition state varies). This allows the remote system to act on a vehicle update with confidence that the vehicle ignition state is accurately reflected by the reported state data.

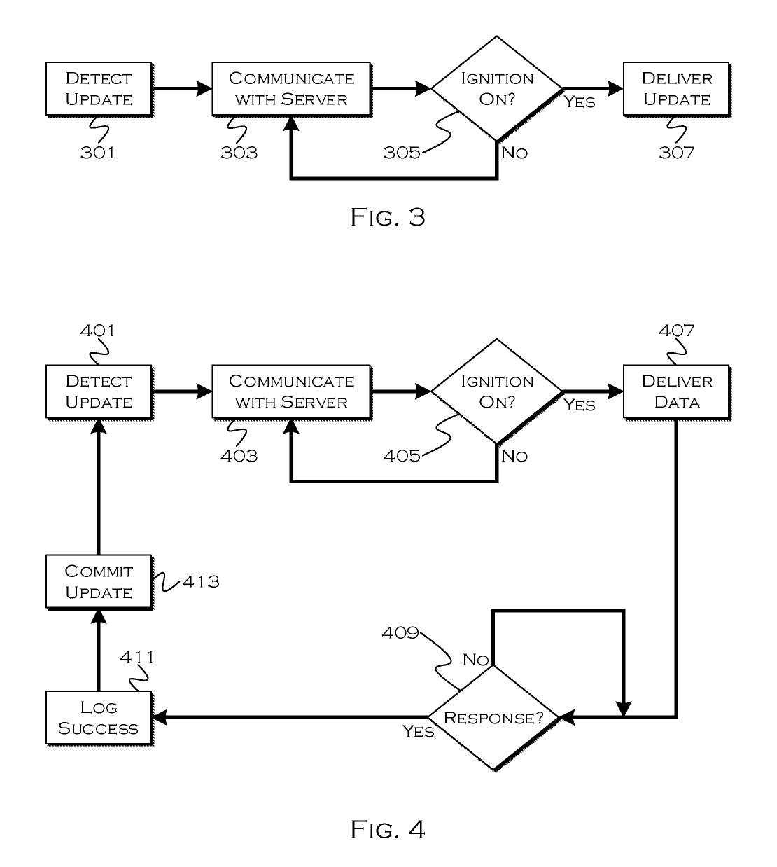

FIG. 3 shows an illustrative example of a delivery instruction process. In this illustrative example, the process detects 301, determines, is informed, etc., that a software update is available. The process then communicates 303 with a watchdog server, which is capable of determining a present ignition state because of a constant connectivity with a vehicle computing system.

If the process determines 305 that the vehicle ignition is on, the process begins to deliver 307 the update. If the vehicle ignition state changes at any point, the process can be immediately informed about the state change, and can pause the update. This allows the process to know how much of an update was delivered with some degree of accuracy, and to ensure that the ignition state is “on” at least when an update is attempted by the process.

FIG. 4 shows an illustrative example of an update confirmation process. In this example, the process again detects 401 the update, or is informed of the existence of an update. The process then communicates 403 with the watchdog server, to determine the present ignition state of a vehicle.

Again, since the watchdog server has a constant connection to the vehicle, the server will know if the ignition state is “on” when the process inquires. If the ignition is on 405, the process will deliver 407 any relevant data (e.g., an update).

Also, in this example, the process on the vehicle-side can respond when an update is completed. If the update process receives 409 an affirmative response, confirming successful update delivery, then the process logs 411 a successful transfer. The process then instructs the vehicle to install the update and commits 413 the update in a process-side registry, indicating that the updates was transferred and installed in the vehicle. This can repeat as long as the process has updates (over time) that need installation, which could be as long as the life of the vehicle.

Another possible issue with systems that rely on SMS messaging for state-indication is that if carriers relocate spectrums this can lead to network congestion and cause circuit switch failures. Or, for example, if carriers switch a format from SMS circuit switch to SMS over another communication technology, a backend server may not be compatible with the new SMS technology, and all SMS messages may fail until the backend can be upgraded for compatibility.

By using the watchdog connection provided by the illustrative embodiments, OEMs can avoid multiple failed transmissions due to incorrect ignition state reporting. This can significantly cut down on pointless transmissions (pointless because the ignition state is not what the server thinks it is) and save both time and cost when sending over the air updates.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined in logical manners to produce situationally suitable variations of embodiments described herein.

What is claimed is:

1. A system comprising:
a processor configured to:
maintain a perpetual connection to a vehicle communication device, barring environmental interference or vehicle communication device failure;
receive data packets from the vehicle communication device indicating an ignition state change; and
determine a present vehicle ignition state based on the data packets.

2. The system of claim 1, wherein the processor is configured to attempt to re-establish the perpetual connection, responsive to resumed connection availability following environmental interference.

3. The system of claim 1, wherein the vehicle communication device includes a cellular modem.

4. The system of claim 1, wherein the processor is configured to report the present vehicle ignition state to an update process.

5. The system of claim 1, wherein the processor is configured to report a change in the present vehicle ignition state, upon determining the present vehicle ignition state has changed from a previously determined vehicle ignition state, to an update process.

6. A system comprising:
a processor configured to:
determine that an update is available for a vehicle;
query a vehicle watchdog process, designed to maintain perpetual vehicle connectivity, absent environmental interference or hardware failure, for a current vehicle ignition state; and
deliver a data payload responsive to receiving an indication from the watchdog process that the vehicle ignition state matches a state designated for payload delivery.

7. The system of claim 6, wherein the vehicle ignition state designated for payload delivery includes an ignition on state.

8. The system of claim 6, wherein the vehicle ignition state designated for payload delivery includes an accessory on state.

9. The system of claim 6, wherein the vehicle ignition state designated for payload delivery includes an ignition off state.

10. The system of claim 6, wherein the data payload includes a software update package.

11. The system of claim 6, wherein the processor is further configured to receive confirmation of a successful payload delivery and log the confirmation in a record indicating a vehicle software status.

12. A computer-implemented method comprising:
maintaining a perpetual connection to a vehicle communication device, absent environmental interference or vehicle communication device failure;
receiving data packets from the vehicle communication device indicating an ignition state change; and
determining a present vehicle ignition state based on the data packets.

13. The method of claim 12, further comprising attempting to re-establish the perpetual connection, responsive to resumed connection availability following environmental interference.

14. The method of claim 12, wherein the vehicle communication device includes a cellular modem.

15. The method of claim 12, further comprising:
determining that an update is available for a vehicle; and
deliver a data payload responsive to determining the vehicle ignition state matches a state designated for payload delivery.

16. The method of claim 15, wherein the vehicle ignition state designated for payload delivery includes an ignition on state.

17. The method of claim 15, wherein the vehicle ignition state designated for payload delivery includes an accessory on state.

18. The method of claim 15, wherein the vehicle ignition state designated for payload delivery includes an ignition off state.

19. The method of claim 15, wherein the data payload includes a software update package.

20. The method of claim 15, further comprising receiving confirmation of a successful payload delivery and logging the confirmation in a record indicating a vehicle software status.
